(19) United States
(12) Patent Application Publication
(10) Pub. No.: US 2021/0018955 A1
(43) Pub. Date: Jan. 21, 2021

(54) THIN LIGHT OPTICAL SYSTEM FOR A WEARABLE VIRTUAL REALITY DISPLAY DEVICE

(71) Applicants: Interface Technology (ChengDu) Co., Ltd., Chengdu (CN); Interface Optoelectronics (ShenZhen) Co., Ltd., Shenzhen (CN); General Interface Solution Limited, Miaoli County (TW)

(72) Inventors: GUO-YANG CIOU, Miaoli County (TW); YUN-PEI CHEN, Miaoli County (TW)

(21) Appl. No.: 16/531,414

(22) Filed: Aug. 5, 2019

(30) Foreign Application Priority Data
Jul. 19, 2019 (CN) 201910656052.7

(51) Int. Cl. G06F 1/16; G02B 27/28; G02B 3/04

(52) U.S. Cl. CPC G06F 1/163; G02B 2003/0093; G02B 3/04; G02B 27/286

(57) ABSTRACT

A thin light optical system of a wearable virtual reality display device having a convex lens and a concave lens. The secondary optical reflection through the convex lens shortens the focal length of the entire optical system to about 16.5 mm, so that the display can be placed 1 mm from the convex lens. The convex lens provides a magnification function of 6 times. The concave lens and the convex lens are made of light material thereby reducing the volume and weight of the virtual reality display device which increases the wearing comfort.

### CROSS REFERENCE TO RELATED APPLICATION

The application is based on, and claims priority from, Chinese Application Serial Number 201910656052.7, filed on Jul. 19, 2019, the disclosure of which is hereby incorporated by reference herein in its entirety.

### BACKGROUND OF THE INVENTION

### Field of the Invention

The invention relates to a virtual reality (VR) display device, and more particularly to a thin and light optical system for a wearable virtual reality display device which reduces the overall weight and increases the wearing comfort for users.

### Description of the Prior Art

Recently, numerous head-mounted display devices have appeared on the market. The optical system design of the device creates virtual images thereby allowing the user to feel like they are in a virtual world.

The conventional wearable glasses on the market need to place the display at a certain distance in front of the lens group in order to achieve zooming functions and increase the field of view. However, such a design can result in a product that is quite large, heavy, unsightly, and uncomfortable to wear.

For example, in the optical system of the virtual reality glasses produced by the Oculus company, as shown in FIG. 1, the head-mounted virtual reality (VR) display device 10 has a total length of about 63 mm and a lens focal length of about 45 mm. If the display is placed 1 mm in front of the lens, the magnification is only 1.02 times. Therefore, to obtain more magnification and optical effects, the position of the display must be placed at a certain distance before the lens. Oculus Rift's design has a light source positioned about 40 mm distance from the front of the lens group, a magnification of about 5-6 times, and a field of view (FOV) of about 90 degrees, thus, leading to a very large, heavy, and unsightly product causing the wearer to feel discomfort,

It can be seen that there are many shortcomings in the above-mentioned conventional devices which need to be improved.

### SUMMARY OF THE INVENTION

In view of the above, the inventor of the present invention has been engaged in the design, manufacturing, and development of related products for many years. After detailed design and careful evaluation of the objectives, the present invention has finally become practical.

An object of the present invention is to provide a thin and light optical system for a wearable virtual reality (VR) display device. The virtual reality display device has a thin and light optical system, which reduces the overall size and weight thereby increasing the wearing comfort.

The thin light optical system of the virtual reality (VR) display device of the present invention comprises a convex lens and a concave lens.

The convex lens is made of a light material and the convex lens comprises a positive meniscus lens, which is disposed 1 mm in distance from the display of the virtual reality display device. The convex lens has a center thickness of 9.5918 mm.

The linear light source of the display is projected through the convex lens and a transimpact film which is the wave front of a birefringent plate (half-wave plate) and into a second optical surface, and then enters a reflective linear polarizer on the rear of the second optical surface of the convex lens, and is reflected back to become linearly polarized light reflected by the optical surface of the front surface of the convex lens (containing anti-wear film).

Reflected again, because of the birefringent wave plate relationship, the linearly polarized light is rotated by an angle, and thus can pass through the rear second optical surface of the reflective linear polarizer.

The concave lens is made of a light material, and the concave lens is disposed 9 mm from the rear of the convex lens. This enables the lens to have a distance between the two to be a concave 9 mm. The thickness of the concave lens is 2 mm. The distance from the concave lens to the human eye is 9 mm, enabling the wearable virtual reality display device to have a total depth or length of 30.1 mm.

The secondary reflecting lens focal length of the entire optical system is shortened to approximately 16.5 mm, so that the display can be placed 1 mm in front of the lens and can still provide a 6 times magnification function. The design employs lightweight material which reduces the size and weight of the virtual reality display device, which increases the wearing comfort.

### BRIEF DESCRIPTION OF THE DRAWINGS

To further understand and understand the purpose, shape, structure and function of the present invention, the present invention will be described in detail and illustrated in the drawings as follows:

FIG. 1 is a drawing showing the appearance of a conventional virtual reality (VR) display device of the prior art;

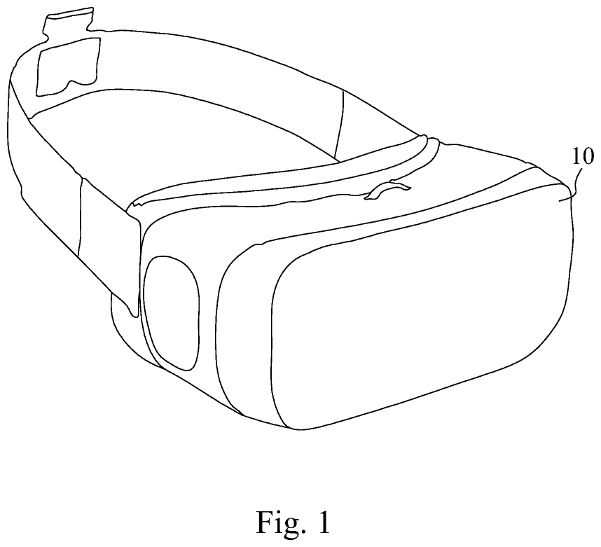

FIG. 2 is a drawing illustrating a light and thin optical display system for a wearable virtual reality (VR) device according to an embodiment of the present invention;

FIG. 3 is a graph showing the modulation transfer function (MTF) test data of the thin light optical system of the wearable virtual reality (VR) display device according to an embodiment of the present invention;

FIG. 4 is a graph showing the lateral color of the thin light optical system of the wearable virtual reality (VR) display device according to an embodiment of the present invention; and

FIG. 5 is a graph showing distortion of the thin light optical system of the wearable virtual reality (VR) display device according to an embodiment of the present invention.

### DESCRIPTION OF THE PREFERRED EMBODIMENTS

The present invention provides a thin light optical system for a wearable virtual reality (VR) display device.

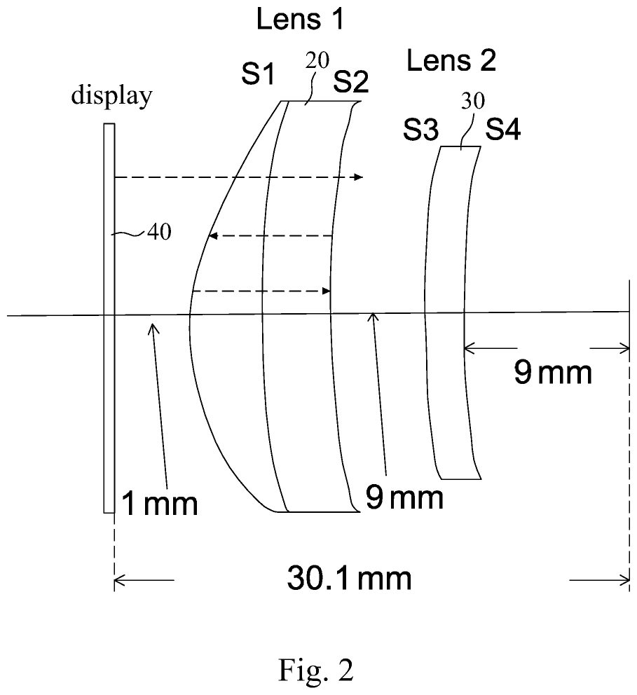

Referring to FIG. 2, the thin light optical system of the present invention for a wearable virtual reality (VR) display device mainly comprises a convex lens 20 and a concave lens 30.

The convex lens 20 is made of a light material and the convex lens 20 is a positive meniscus lens, which is disposed 1 mm away from the display 40 of the wearable virtual reality display device (not shown).

The convex lens 20 in the center has a thickness of 9.5918 mm , and the linear light source of the display 40 is projected through the front first optical surface S1 of the convex lens 20 including a transflective film and a birefringent wave plate (half wave plate), and then becomes reflected line polarized light.

The rear second optical surface S2 of the convex lens 20 reflects the light back, and the reflected linearly polarized light reaches the front first optical surface S1 (including the transversal film) to be reflected again. Because of the birefringent wave plate relationship, the linearly polarized light is rotated by an angle, so it can pass through the rear second optical surface S2 having the reflective line polarizer.

The concave lens system 30 is made of a light material and the concave lens 30 is positioned 9 mm behind the convex lens 20. The thickness of the concave lens 30 is 2 mm. The distance from the concave lens 30 to the human eye is 9 mm, so that the total depth or length of the virtual reality display device is 30.1 mm.

The focal length of the entire optical system is shortened to about 16.5 mm by the secondary reflection of the convex lens 20. The convex lens 20 can still provide a magnification function of 6 times at a distance of 1 mm to the display 40.

Generally, the virtual reality (VR) display device on the market has a focal lens group lens of about 40-50 mm, so it is necessary to place a 30-40 mm distance in front of the lens to have an amplification function.

By the composition of the above-mentioned components, the focal length of the entire optical system is shortened to about 16.5 mm by the secondary reflection of the convex lens 20. As a result, the display 40 can be placed at a distance of 1 mm from the convex lens 20 and still provide a magnifying function of 6 times. The convex lens 20 and the concave lens 30 are comprised a light material in order to reduce the size and weight of the virtual reality display device thereby increasing wearing comfort.

The total depth or length of the virtual reality display device is 30.1 mm, which greatly reduces the volume of the entire head mounted device. Also, the light source of the display 40 can be enlarged by 6 times at a distance of 1 mm from the front of the lens group.

In an embodiment of the present invention the convex lens 20 comprises a plastic lens to reduce the weight.

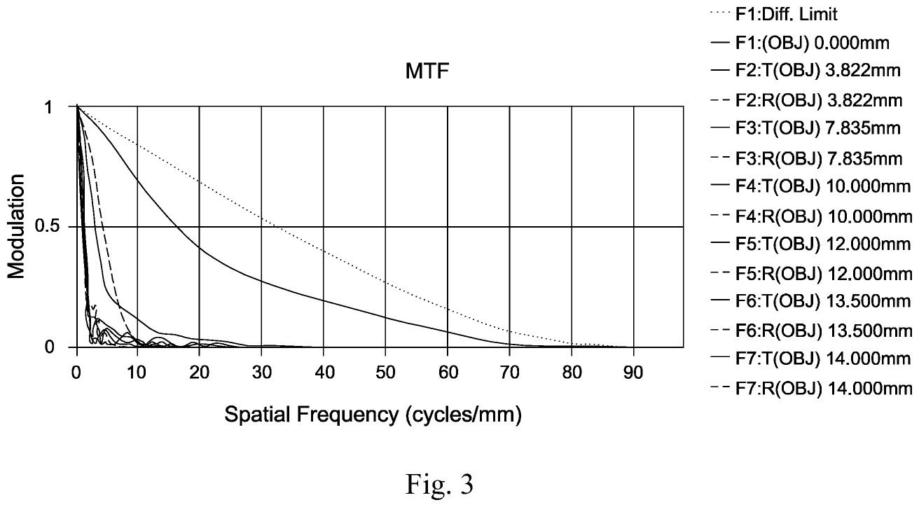

In an embodiment the concave lens 30 comprises a plastic lens to reduce weight. Refer to FIG. 3. In the thin light optical system of the present invention, the lens combination of the convex lens 20 and the concave lens 30 was tested for the contrast of the imaging. The contrast of the central field of view was about 16 cycles/mm (modulation transfer function (MTF)=0.5).

Due to the dispersion phenomenon, the refractive indices of different wavelengths in the material are also different, causing the positional deviation of the imaging points of each wavelength.

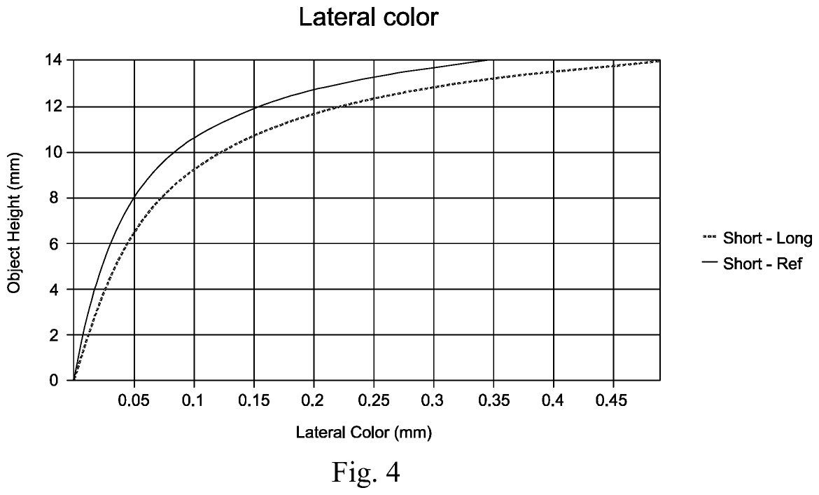

Refer to FIG. 4. In the thin light optical system of the present invention, the convex lens 20 and the concave lens 30 are combined to make the chromatic aberration smaller than 0.5 mm.

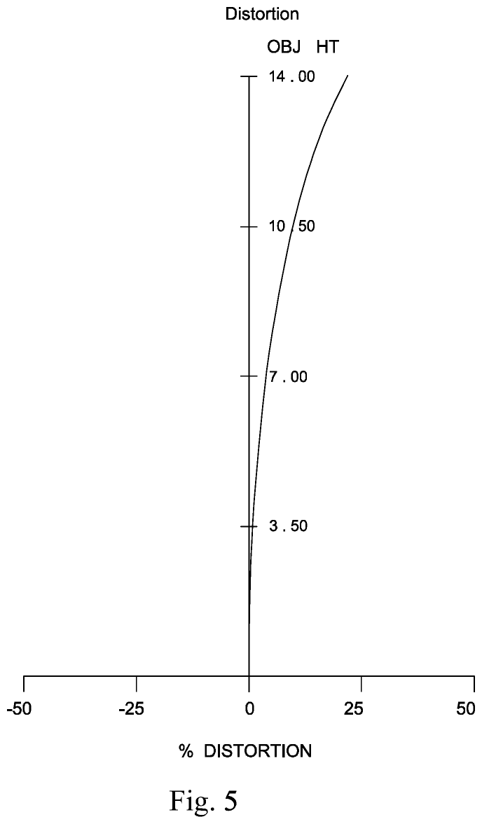

Refer to FIG. 5. In the thin light optical system of the present invention, the distortion of the convex lens 20 and the concave lens 30 was tested to be 25%.

In the thin light optical system of the present invention, the optical system design of the convex lens 20 and the concave lens 30 has a field of view FOV=91°, which is enough to make people immersed in the virtual world.

In summary, the thin and light optical system of a wearable virtual reality (VR) display device of the present invention has an unprecedented innovative structure, which is not found in any publication, and there is no similar product on the market. Therefore, its novelty should be undoubted. In addition, the unique features and functions of the present invention are far from comparable to the conventional ones, so it is indeed more progressive than the conventional ones.

The above description is only the best embodiments of the present invention, but the structural features of the present invention are not limited thereto, and any change or modification that can be easily considered by those skilled in the art can be covered.

What is claimed is:

1. A thin light optical system of a wearable virtual reality (VR) display device, comprising:
a convex lens made of a light material, the convex lens being a positive meniscus lens, which is disposed 1 mm from a display of the wearable virtual reality display device, a center thickness of the convex lens being 9.5918 mm, so that light emitted by a linear light source is projected through the convex lens, the convex lens comprises a front first optical surface comprising a transflective film and a birefringent wave plate (half wave plate), and then enters a rear second optical surface comprising a reflective polarizer and is reflected back where it encounters the front first optical surface with the transreflective film, and is reflected again;
wherein because of the birefringent wave plate relationship, linearly polarized light is rotated by an angle, and thus can pass through the reflective linear polarizer of the rear second optical surface; and
a concave lens made of a light material, the concave lens is disposed 9 mm behind the convex lens, the distance between the convex lens and the concave lens is 9 mm, thickness of the concave lens is 2 mm, and the distance of the concave lens to a human eye is 9 mm, enabling the wearable virtual reality display device to have a total length of 30.1 mm, the secondary reflecting lens focal length of the entire optical system is shortened to approximately 16.5 mm, so that the display can be placed in front of the convex lens at 1 mm and still provide a magnification function of 6 times.

2. The thin light optical system of a wearable virtual reality (VR) display device of claim 1, wherein the convex lens comprises a plastic lens.

3. The thin light optical system of a wearable virtual reality (VR) display device of claim 1, wherein the concave lens comprises a plastic lens.

4. The thin light optical system of a wearable virtual reality (VR) display device of claim 1, wherein the convex lens and concave lens in combination increase the contrast of an image, and contrast of a center of field of view is 16 cycle/mm (Modulation transfer function (MTF)=0.5) .

5. The thin light optical system of a wearable virtual reality (VR) display device of claim 1, wherein chromatic aberration of the concave lens and the convex lens in combination is less than 0.5 mm.

6. The thin light optical system of a wearable virtual reality (VR) display device of claim 1, wherein convex lens and concave lens distortion of an image is 25%.

7. The thin light optical system of a wearable virtual reality (VR) display device of claim 1, wherein field of view of the convex lens and the concave lens is 91 degrees.
